(19) United States
(12) Patent Application Publication
(10) Pub. No.: US 2004/0241334 A1
(43) Pub. Date: Dec. 2, 2004

(54) Method for impregnating bottle corks

(76) Inventor: Klause Angermaier, Munchen (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/489,932

(22) PCT Filed: Sep. 12, 2002
(86) PCT No.: PCT/EP02/10261

(30) Foreign Application Priority Data
Sep. 27, 2001 (DE) 101 47 626.4

(51) Int. Cl. B05D 1/18

(52) U.S. Cl. 427/430.1

(57) ABSTRACT

Disclosed is a novel method for impregnating bottle corks, wherein the bottle corks are treated with silicon rubber materials, which can be cross-linked to form elastomers, containing organopolysiloxanes comprising (1) radicals with aliphatic carbon-carbon multiple bonds, (2) organopolysiloxanes with Si-bonded hydrogen atoms (3), catalysts promoting the attachment of Si-bonded hydrogen to aliphatic multiple bonds, and optionally (4) agents which delay the attachment of Si-bonded hydrogen to aliphatic multiple bonds, characterized in that the organopolysiloxanes (2) contain 1.02.0 wt. % Si-bonded hydrogen.

The invention relates to a process for impregnating bottle corks with silicone rubber compositions which can be crosslinked to elastomers.

In EP-A 773 090 bottle corks are impregnated with a two-component silicone rubber in a vacuum process. The advantage of this process is to furnish corks of low quality with improved sealing properties and also to reduce the extraction of aromatic constituents in the cork which impair the taste of the beverage, such as trichloroanisole, and thereby to raise the value of the cork. The drawback of this process is that the silicone rubber does not adhere to the cork. In the course of introduction into the neck of the bottle the silicone rubber is abraded. The fragments of silicone remain visible in the beverage and therefore make the cork unusable.

The object was to provide a process for impregnating bottle corks with silicone rubber compositions which can be crosslinked to elastomers, in which the above-described drawbacks are avoided and the silicone rubber adheres to the surface of the corks and cannot be abraded. This object is achieved by means of the invention.

The invention provides a process for impregnating bottle corks wherein the bottle corks are treated with silicone rubber compositions which can be crosslinked to elastomers and comprise

(1) organopolysiloxanes having residues containing aliphatic carbon-carbon multiple bonds,

(2) organopolysiloxanes containing Si-bonded hydrogen atoms,

(3) catalysts which promote the addition of Si-bonded hydrogen to aliphatic multiple bonds,

and, if desired,

(4) agents known as inhibitors, which retard the addition of Si-bonded hydrogen to aliphatic multiple bonds,

characterized in that the organopolysiloxanes (2) contain from 1.0 to 2.0% by weight of Si-bonded hydrogen.

The compositions of the invention comprising the constituents (1), (2), (3), and, if desired, (4) are prepared preferably in the form of two-component compositions, with constituents (2) and (3) being separated from one another.

The silicone rubber compositions which can be crosslinked to elastomers are therefore preferably two-component compositions wherein component (A) comprises organopolysiloxane (1), catalyst (3), and, if desired, inhibitor (4) and

component (B) comprises organopolysiloxane (2) and also, if desired, additional organopolysiloxane (1) and, if desired, inhibitor (4).

The addition-crosslinking silicone rubber composition Elastosil® M4600 which is used in the above-mentioned EP-A 773 090 comprises as crosslinker an organopolysiloxane containing Si-bonded hydrogen atoms, having from 0.14 to 0.17% by weight of Si-bonded hydrogen.

By bottle corks are meant stoppers made of cork material which are intended for closing beverage bottles, such as wine bottles, for example.

Organopolysiloxanes (1) used are preferably linear or branched organopolysiloxanes comprising units of the general formula

$${R}_{a} {R}_{b}^{1} {SiO}_{\frac{4 - a - b}{2}} , \qquad ( I )$$

where each R is identical or different and is a monovalent, optionally substituted hydrocarbon radical having 1 to 18 carbon atom(s) per radical and each R¹ is identical or different and is a monovalent hydrocarbon radical having a terminal, aliphatic carbon-carbon multiple bond and having 2 to 8 carbon atoms per radical,

a is 0, 1, 2, or 3,

b is 0, 1 or 2,

and the sum a+b is <3,

with the proviso that the organopolysiloxanes of the formula (I) contain at least 2 radicals R¹ per molecule.

R is preferably a hydrocarbon radical which is free from aliphatic carbon-carbon multiple bonds. Examples of radicals R are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical; cycloalkyl radicals, such as cyclopentyl, cyclohexyl, cycloheptyl, and methylcyclohexyl radicals; aryl radicals, such as the phenyl, naphthyl, anthryl, and phenanthryl radical; alkaryl radicals, such as o-, m-, and p-tolyl radicals, xylyl radicals, and ethylphenyl radicals; and aralkyl radicals, such as the benzyl radical, the α- and the β-phenylethyl radical.

Examples of substituted radicals R are haloalkyl radicals, such as the 3,3,3-trifluoro-n-propyl radical, the 2,2,2,2′,2′,2′-hexafluoroisopropyl radical, the heptafluoroisopropyl radical, and haloaryl radicals, such as the o-, m-, and p-chlorophenyl radical.

The radical R is preferably a monovalent hydrocarbon radical having 1 to 6 carbon atoms, the methyl radical being particularly preferred.

Examples of radicals R¹ are alkenyl radicals, such as the vinyl, 5-hexenyl, cyclohexenyl, 1-propenyl, allyl, 3-butenyl, and 4-pentenyl radical, and alkynyl radicals, such as the ethynyl, propargyl, and 1-propynyl radical.

The radical R¹ preferably comprises alkenyl radicals, the vinyl radical being particularly preferred.

It is possible to use one kind of organopolysiloxane (1) or different kinds of organopolysiloxanes (1).

Preferred organopolysiloxanes (1) are those of the general formula

R¹_{g}R_{3-g}SiO(SiR₂O)ₙ(SiRR¹O)ₘSiR_{3-g}R¹_{g} (II)

where R and R¹ are as defined above,

g is 0, 1, 2 or 3, preferably 1,

m is 0 or an integer from 1 to 500, and

n is an integer from 70 to 1 000,

with the proviso that the organopolysiloxanes of the formula (II) contain at least 2 radicals R¹ per molecule.

For the purposes of this invention formula (II) is to be understood such that n units —(SiR₂O)— and m units —(SiRR¹O)— can be distributed arbitrarily, blockwise or randomly, in the organopolysiloxane molecule.

The organopolysiloxanes (1) possess an average viscosity of preferably from 100 to 100 000 mPa.s at 25° C., preferably from 1 000 to 20 000 mPa.s at 25° C.

Organopolysiloxanes (2) are used as crosslinkers in the addition crosslinking of the silicone rubber compositions of the invention.

As organopolysiloxanes (2) it is preferred to use linear, cyclic or branched organopolysiloxanes comprising units of the general formula

$${R}_{e} {H}_{f} {SiO}_{\frac{4 - e - f}{2}} , \qquad ( III )$$

where

R is as defined above,

e is 0, 1, 2 or 3,

f is 0, 1 or 2,

and the sum of e+f is ≦3,

with the proviso that the organopolysiloxanes of the formula (III) contain from 1.0 to 2.0% by weight of Si-bonded hydrogen.

As organopolysiloxanes (2) it is preferred to use those of the general formula

HₕR_{3- h}SiO(SiR₂O)ₒ(SiR_{2- x}HₓO)ₚSiR_{3- h}Hₕ (IV)

where R is as defined above,

h is 0, 1 or 2, preferably 0,

o is 0 or an integer from 1 to 1 000, preferably 0,

p is an integer from 1 to 1 000, preferably from 40 to 70, and

x is 1 or 2, preferably 1,

with the proviso that the organopolysiloxanes of the formula (IV) contain from 1.0 to 2.0% by weight, preferably from 1.5 to 1.7% by weight, of Si-bonded hydrogen.

For the purposes of this invention formula (IV) is to be understood such that o units —(SiR₂O)— and p units —(SiR₂—HₓO)— can be distributed arbitrarily, blockwise or randomly, in the organopolysiloxane molecule.

Examples of organopolysiloxanes (2) are, in particular, copolymers comprising dimethylhydrosiloxane, methylhydrosiloxane, dimethylsiloxane, and trimethylsiloxane units, copolymers comprising trimethylsiloxane, dimethylhydrosiloxane, and methylhydrosiloxane units, copolymers comprising trimethylsiloxane, dimethylsiloxane, and methylhydrosiloxane units, copolymers comprising methylhydrosiloxane and trimethylsiloxane units, copolymers comprising methylhydrosiloxane, diphenylsiloxane, and trimethylsiloxane units, copolymers comprising methylhydrosiloxane, dimethylhydrosiloxane, and diphenylsiloxane units, copolymers comprising methylhydrosiloxane, phenylmethylsiloxane, trimethylsiloxane and/or dimethylhydrosiloxane units, copolymers comprising methylhydrosiloxane, dimethylsiloxane, diphenylsiloxane, trimethylsiloxane and/or dimethylhydrosiloxane units, and copolymers comprising dimethylhydrosiloxane, trimethylsiloxane, phenylhydrosiloxane, dimethylsiloxane and/or phenylmethylsiloxane units.

It is possible to use one kind of organopolysiloxane (2) or different kinds of organopolysiloxanes (2).

The organopolysiloxanes (2) possess an average viscosity of preferably from 10 to 100 000 mPa.s at 25° C., more preferably from 10 to 500 mPa.s at 25° C., very preferably from 10 to 30 mPa.s at 25° C.

Besides the organopolysiloxanes (2) rich in Si-bonded hydrogen it is also possible for the compositions of the invention to comprise organopolysiloxanes (2′) of the general formula

HᵥR_{3- v}SiO(SiR₂O)ₛ(SiRHO)ₜSiR_{3- v}Hᵥ (IV′)

where R is as defined above,

v is 0, 1 or 2,

s is 0 or an integer from 1 to 1 000,

t is 0 or an integer from 1 to 1 000,

with the proviso that the organopolysiloxanes of the formula (IV′) contain at least 2 Si-bonded hydrogen atoms per molecule but less than 1.0% by weight of Si-bonded hydrogen.

With v=1 and t=0 in formula (IV′) the compounds in question are, for example, α, ω-dihydroorganopolysiloxanes, which act as chain extenders.

The organopolysiloxanes (2′) possess an average viscosity of preferably from 10 to 100 000 mPa.s at 25° C., more preferably from 10 to 500 mPa.s at 25° C.

In the silicone rubber compositions of the invention organopolysiloxane (2) is used preferably in amounts of from 0.01 to 20% by weight, based on the total weight of the organopolysiloxanes (1).

In the silicone rubber compositions of the invention organopolysiloxane (2′) is used preferably in amounts of from 0 to 100% by weight, based on the total weight of the organopolysiloxanes (1).

As catalysts (3) which promote the addition of Si-bonded hydrogen to aliphatic multiple bond it is also possible in the silicone rubber compositions of the invention to use the same catalysts which it has also been possible to date to use to promote the addition of Si-bonded hydrogen to aliphatic multiple bond. The catalysts preferably comprise a metal from the group of the platinum metals group or a compound or complex from the platinum metals group. Examples of such catalysts are metallic and finely divided platinum, possibly on supports, such as silica, alumina or activated carbon, compounds or complexes of platinum, such as platinum halides, e.g., PtCl₄, H₂PtCl₆*6H₂O, Na₂PtCl₄*4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₆*6H₂O and cyclohexanone, platinum-vinylsiloxane complexes, such as platinum-1,3-divinyl-1,1,3,3-tetramethyldisiloxane complexes with detectable inorganically bonded halogen present or absent, bis(gamma-picoline)-platinum dichloride, trimethylenedipyridine-platinum dichloride, dicyclopentadiene-platinum dichloride, dimethyl sulfoxide-ethylene-platinum (II) dichloride, cyclooctadiene-platinum dichloride, norboradiene-platinum dichloride, gamma-picoline-platinum dichloride, cyclopentadiene-platinum dichloride, and also reaction products of platinum tetrachloride with olefin and primary amine or secondary amine or primary and secondary amine, such as the reaction product of platinum tetrachloride in solution in 1-octene with sec-butylamine, or ammonium-platinum complexes.

In the silicone rubber compositions of the invention the catalyst (3) is used preferably in amounts of from 0.001 to 0.1% by weight, in each case calculated as elemental platinum and based on the total weight of the organopolysiloxanes (1) and (2).

As inhibitors (4) it is possible in the silicone rubber compositions of the invention as well to use all inhibitors which it has also been possible to date to use for the same purpose.

Examples of inhibitors (4) are 1,3-divinyl-1,1,3,3-tetramethyldisiloxane, benzotriazole, dialkyl-formamides, alkylthioureas, methyl ethyl ketoxime, organic or organosilicon compounds having a boiling point of at least 25° C. at 1012 mbar (abs.) and at least one aliphatic triple bond, such as 1-ethynylcyclohexan-1-ol, 2-methyl-3-butyn-2-ol, 3-methyl-1-pentyn-3-ol, 2,5-dimethyl-3-hexyne-2,5-diol and 3,5-dimethyl-1-hexyn-3-ol, 3,7-dimethyloct-1-in-6-en-3-ol, a mixture of diallyl maleate and vinyl acetate, maleic monoesters, and inhibitors such as the compound of the formula HC═C—C(CH₃) (OH)—CH₂—CH₂—CH═C(CH₃)₂, available commercially under the trade name “Dehydrolinalool” from BASF.

The inhibitor (4) is used in amounts of preferably from 0.001 to 10% by weight, preferably, based on the total weight of the organopolysiloxanes (1) and (2).

The silicone rubber compositions of the invention may comprise further constituents such as fillers (5), such as reinforcing and nonreinforcing fillers, and resinous organopolysiloxanes, such as MQ resins (6).

The further constituents may be present in component (A) and/or (B).

Examples of reinforcing fillers (5a), i.e., fillers having a BET surface area of at least 50 m²/g, are pyrogenically produced silica, precipitated silica or silicon-aluminum mixed oxides having a BET surface area of more than 50 m²/g. The fillers stated may have been rendered hydrophobic, by means for example of treatment with organosilanes, organosilazanes or organosiloxanes or etherification of hydroxyl groups to alkoxy groups. Preference is given to pyrogenically produced silicas having a BET surface area of at least 100 m²/g.

The silicone rubber compositions of the invention contain reinforcing fillers (5a) in amounts of preferably from 0 to 20% by weight.

Examples of nonreinforcing fillers (5b), i.e. fillers having a BET surface area of less than 50 m²/g, are powders of quartz, cristobalite, diatomaceous earth, calcium silicate, zirconium silicate, montmorillonites, such as bentonites, zeolites including the molecular sieves, such as sodium aluminum silicate, metal oxides, such as iron oxide, zinc oxide, titanium dioxide, and aluminum oxide, and their mixed oxides, metal hydroxides, such as aluminum hydroxide, metal carbonates, such as calcium carbonate, magnesium carbonate, and zinc carbonate, metal sulfates, such as barium sulfate, gypsum, silicon nitride, silicon carbide, boron nitride, powdered glass, powdered carbon and powdered polymers, and hollow glass and plastic beads.

The silicone rubber compositions of the invention contain nonreinforcing fillers in amounts of preferably from 0 to 50% by weight.

It is possible to use one kind of filler although it is also possible to use a mixture of at least two fillers.

The resinous organopolysiloxanes preferably comprise monofunctional (M) and trifunctional (T) and/or tetrafunctional (O) units, and also difunctional (D) units where appropriate. Preference is given to the resins known as MQ resins (6), which are composed of monofunctional and tetrafunctional units. The monofunctional units may contain as functional groups unsaturated hydrocarbon radicals, such as alkenyl groups, or Si-bonded hydrogen.

Preferred MQ resins (6) are those comprising units of the formulae

R⁵R₂SiO_{1/2} and SiO_{4/2}

where R⁵ is a radical R, a hydrogen atom or a radical R¹ and R and R¹ are as defined above, and the units of the formula R⁵R₂SiO_{1/2} can be identical or different.

The ratio of M units of the formula R⁵R₂SiO_{1/2} to Q units of the formula SiO_{4/2} is preferably from 4:1 to 1:2.

Examples of MQ resins (6a) containing unsaturated M units are those comprising units of the formulae SiO_{4/2} and R¹R₂SiO_{1/2} and, if desired, R₃SiO_{1/2}, i.e., MQ resins containing exclusively unsaturated M units or MQ resins containing saturated and unsaturated M units, where R and R¹ are as defined above and the ratio of M units R¹R₂SiO_{1/2} and, where present, R₃SiO_{1/2} to Q units SiO_{4/2} is preferably from 4:1 to 1:2 and the ratio of saturated M units R₃SiO_{1/2} to unsaturated M units R¹R₂SiO_{1/2} is preferably from 10:1 to 0:1.

The MQ resins (6a) are used preferably in amounts of from 0 to 100% by weight, based on the total weight of the organopolysiloxanes (1).

Further examples of MQ resins (6b) containing M units containing Si-bonded hydrogen are those comprising units of the formulae

SiO_{4/2} and HR₂SiO_{1,2} and, if desired, R₃SiO_{1/2},

i.e., MQ resins containing only M units containing Si-bonded hydrogen,

or MQ resins containing M units with and without Si-bonded hydrogen,

which are preferably present in component (B),

where R is as defined above and the ratio of M units HR₂SiO_{1/2} and, where present, R₃SiO_{1/2} to Q units SiO_{4/2} is preferably from 4:1 to 1:2 and the ratio of M units R₃SiO_{1/2} to M units HR₂SiO_{1/2} is preferably from 10:1 to 0:1.

The MQ resins (6b) are used preferably in amounts of from 0 to 20% by weight, based on the total weight of the organopolysiloxanes (1).

Organopolysiloxane (2) of the invention is present in the crosslinkable silicone rubber composition in an amount such that the molar ratio of SiH groups in organopolysiloxane (2) to Si-bonded radical R¹ containing aliphatic carbon-carbon multiple bond in organopolysiloxane (1) and MQ resin (6a) (ratio SiHₛᵢₗₒₓₐₙₑ₍₂₎/C=Cₜₒₜₐₗ) is preferably from 0.01 to 10.0, more preferably from 0.1 to 2.0.

The total amount of all SiH groups in the silicone rubber compositions of the invention is such that the molar ratio of SiH groups in the organopolysiloxane (2), (2′), and MQ resin (6b) to Si-bonded radical R¹ containing aliphatic carbon-carbon multiple bond in organopolysiloxane (1) and MQ resin (6a) (ratio SiHₜₒₜₐₗ/C=Cₜₒₜₐₗ) is preferably from 1.0 to 10.0, more preferably from 1.7 to 5.0.

Components (A) and (B) are used in a weight ratio preferably from 100:1 to 1:100, more preferably 1:1.

The silicone rubber compositions of the invention possess a viscosity of preferably from 500 to 20 000 mPa·s at 25° C., more preferably from 1500 to 10 000 mPa·s at 25° C.

The silicone rubber compositions of the invention have a pot life at 25° C. of preferably from 12 hours to 2 weeks, more preferably from 1 to 5 days.

The bottle corks are treated preferably in accordance with the process described in the abovementioned EP-A 773 090 (incorporated by reference).

The bottle corks used are standard commercial bottle corks having a weight of preferably from 2.5 to 4.0 g.

The treatment of the bottle corks preferably comprises

(a) dipping the bottle corks in the silicone rubber compositions of the invention which can be crosslinked to elastomers,

(b) mechanically removing excess silicone rubber compositions from the bottle corks, and

(c) crosslinking the silicone rubber compositions.

The silicone rubber compositions of the invention can be used without further dilution with organic solvent.

The bottle corks are coated in accordance with the customary prior art methods for vacuum impregnation processes.

During the dipping of the bottle corks a vacuum of preferably from 0.1 to 0.005 bar is applied. Dipping preferably takes place within a period of from 5 to 20 minutes. Thereafter the vacuum is broken.

Excess silicone rubber composition is removed mechanically, e.g., by stripping, from the surface of the bottle corks.

On the surface of the bottle corks there therefore remains preferably a small amount of not more than 0.1 g of silicone rubber composition, i.e., the layer thickness of the silicone rubber on the surface is preferably from 10 to 30 μm.

The amount of absorbed silicone rubber composition is determined essentially by the nature of the bottle cork, i.e., the fraction of cavities, the engineering parameters chosen during coating, and the efficiency of the chosen method of mechanically removing excess silicone rubber composition from the surface of the bottle corks.

The bottle corks preferably absorb from 0.5 to 1.0 g of silicone rubber composition; in other words, the weight increase of the bottle corks is preferably from 10 to 40% by weight.

The silicone rubber compositions of the invention are crosslinked preferably under the pressure of the surrounding atmosphere, i.e., approximately at 1020 hPa, but can also be conducted under higher or lower pressures.

Crosslinking is conducted preferably at a temperature of from 50° C. to 70° C., more preferably at 60° C.

The curing time of the silicone rubber compositions of the invention is preferably from 30 to 300 minutes, more preferably from 90 to 180 minutes, at the temperature stated above.

The vulcanization reactivity of the silicone rubber compositions of the invention is matched to the process in such a way that on the one hand they have a sufficiently long pot life for processing and the other a sufficiently rapid cure rate.

The process of the invention has the advantage that bottle corks having good sealing properties are obtained. The process of the invention has the further advantage that the silicone rubber of the invention adheres well to the surface of the bottle corks and is not abraded during the introduction of the cork into the bottle.

### EXAMPLES 1 TO 4

The constituents indicated in Tables 1 to 4 are mixed and in each case one component A and one component B are prepared.

Each of the components A and B obtained are then mixed in a 1:1 ratio.

TABLE 1

| Component A | Parts by weight | Component B | Parts by weight |
|---|---|---|---|
| Vi-polymer 20 000 | 535 | Vi-polymer | 300 |
| | | 20 000 | |
| Vi-polymer 1 000 | 535 | Vi-polymer 1 000 | 300 |
| HDK | 30 | H 1 000 | 500 |
| Pt catalyst | 4.2 | H-siloxane | 2 |
| Inhibitor | 0.6 | | |

Pot life of the mixture A+B is 48 hours at 25° C.

TABLE 2

| Component A | Parts by weight | Component B | Parts by weight |
|---|---|---|---|
| Vi-polymer 1 000 | 500 | Vi-polymer 1 000 | 520 |
| HDK | 30 | QM-H resin | 10 |
| Pt catalyst | 2.1 | H-siloxane | 0.5 |
| Inhibitor | 0.4 | | |

Pot life of the mixture A+B is 38 hours at 25° C.

TABLE 3

| Component A | Parts by weight | Component B | Parts by weight |
|---|---|---|---|
| Vi-polymer 7 000 | 400 | Vi-polymer 7 000 | 500 |
| QM-Vi resin | 100 | Metal oxides | 2 |
| Pt catalyst | 6.4 | H-siloxane | 4 |
| Inhibitor | 1 | | |

Pot life of the mixture A+B is 72 hours at 25° C.

TABLE 4

| Component A | Parts by weight | Component B | Parts by weight |
|---|---|---|---|
| Vi-polymer 20 000 | 210 | Vi-polymer | 195 |
| | | 20 000 | |
| Vi-polymer 1 000 | 725 | Vi-polymer 1 000 | 610 |
| QM-Vi resin | 140 | QM-Vi resin | 120 |
| Metal oxides | 20 | Crosslinker 525 | 162 |
| Pt catalyst | 2 | H-siloxane | 10 |
| | | Inhibitor | 0.3 |

Pot life of the mixture A+B is 30 hours at 25° C.

The constituents indicated in Tables 1 to 4 have the following compounds, where Me=methyl radical and

Vi=Vinyl Radical:

Vi-Polymer 1 000:

Organopolysiloxane of formula: ViMe₂SiO(Me₂SiO)ₙ¹SiMe₂Vi n¹=200 having a viscosity of 1 000 mPa·s at 25° C.

Vi-Polymer 7 000:

Organopolysiloxane of formula: ViMe₂SiO(Me₂SiO)ₙ²SiMe₂Vi n²=450 having a viscosity of 7 000 mPa·s at 25° C.

Vi-Polymer 20 000:

Organopolysiloxane of formula: ViMe₂SiO(Me₂SiO)ₙ³SiMe₂Vi n³=600 having a viscosity of 20 000 mPa·s at 25° C.

H-Siloxane:

Organopolysiloxane of formula: Me₃SiO (MeHSiO)ₙ⁴SiMe₃ n⁴=50 having a viscosity of 1 000 mPa·s at 25° C. and containing 1.6% by weight of Si-bonded hydrogen.

H 1 000:

Organopolysiloxane of formula: HMe₂SiO(Me₂SiO)ₙ⁵SiMe₂H n=200 having a viscosity of 1 000 mPa·s at 25° C. and containing 0.013% by weight of Si-bonded hydrogen.

Crosslinker 525:

Organopolysiloxane of Formula:

Me₃SiO(MeHSiO)ₙ⁶(Me₂SiO)ₙ⁷SiMe₃ n⁶+n⁷=200, n⁶:n⁷=1:2 having a viscosity of 400 mPa·s at 25° C. and containing 0.5% by weight of Si-bonded hydrogen.

QM-Vi Resin:

Resin comprising units of the formula SiO₄₁₂ (O), Me₃SiO₁₁₂ (M) and ViMe₂SiO_{1,2} (M_{V}), having a Q:M:Mᵥ ratio of 1:0.1:0.6

QM-H Resin:

Resin comprising units of the formula SiO_{4/2} (Q), HMe₂SiO_{1/2} (M_{H}), having a Q:M_{H} ratio of 1:2

HDK:

Pyrogenically produced silica having a BET surface area of 125 m²/g (obtainable commercially under the trade name WACKER HDK®S13 from Wacker-Chemie GmbH).

Metal Oxides:

Mixture of different metal oxides containing titanium dioxide and iron oxides obtainable commercially under the trade names

Kronos® 2056 from Kronos Titan,

SICOTAN® Gelb (yellow) K 1011 from BASF AG and

BAYFERROX® 610 from Bayer AG.

The mixing ratio of these three compounds is 10:10:1.

The mixing ratio was chosen so as to give a color as close as possible to that of natural cork.

Inhibitor: Ethynylcyclohexanol

Pt catalyst:

Solution of a platinum-1,3-divinyl-1,1,3,3-tetramethyldisiloxane complex in dimethylpolysiloxane, this solution having a platinum content of 1% by weight

Comparative Composition from EP-A 773 090:

An addition-crosslinking two-component silicone rubber composition is used which is available under the trade name Elastosil® M4600 from Wacker-Chemie GmbH. The crosslinker, a linear H-siloxane containing lateral Si-bonded hydrogen atoms, of the formula

Me₃SiO(MeHSiO)_{y}(Me₂SiO)_{z}SiMe₃ with y:z=1:10,

possesses an Si-bonded hydrogen content of from 0.14 to 0.17% by weight.

Components A and B are mixed in a 10:1 ratio.

### EXAMPLES 5 and COMPARATIVE EXPERIMENT

Standard commercial bottle corks weighing 3.3 g with a diameter of 24 mm and a length of 45 mm are each dipped in the silicone rubber mixtures from Examples 1 to 4 or into the comparative composition from EP-A 773 09 and subjected to vacuum impregnation at 10 mbar for 15 minutes. After the vacuum has been removed, excess silicone rubber mixture is removed mechanically from the surface of the bottle corks. The coated bottle corks are cured in an oven at 60° C. for 120 minutes.

The adhesion of the silicone rubber to the cork surface is tested as follows:

Two corks treated with the silicone rubber compositions of the invention are rubbed with their outer surfaces against one another. The corks show no abrasion whatsoever.

When bottles are closed with these corks there is no abrasion of the silicone rubber from the cork surface.

Analogously, two corks treated with the silicone rubber composition from the comparative experiment are rubbed by their outer surfaces against one another. The vulcanized silicone rubber is abraded in the form of small particles. When bottles are closed using such corks there is abrasion of the silicone rubber from the surface of the corks, and this, in the form of small vulcanizate particles, contaminates the bottle contents.

1-5. Cancelled.

6. A process for impregnating bottle corks, comprising treating bottle corks with a silicone rubber composition which can be crosslinked to an elastomer, said silicone rubber composition comprising:
(1) one or more organopolysiloxanes having residues containing aliphatic carbon-carbon multiple bonds,
(2) one or more organopolysiloxanes containing Si-bonded hydrogen atoms,
(3) at least one catalyst which promotes the addition of Si-bonded hydrogen to aliphatic multiple bonds, and,
(4) optionally, one or more inhibitors which retard the addition of Si-bonded hydrogen to aliphatic multiple bonds,
with the proviso that the organopolysiloxanes (2) contain from 1.0 to 2.0% by weight of Si-bonded hydrogen.

7. The process of claim 6, wherein the silicone rubber compositions are two-component compositions wherein component (A) comprises organopolysiloxane (1), catalyst (3), and optionally, inhibitor (4), and
component (B) comprises organopolysiloxane (2), optionally additional organopolysiloxane (1), and optionally, inhibitor (4).

8. The process of claim 6, wherein at least one organopolysiloxane (1) is one of the formula
R¹_{g}R_{3- g}SiO(SiR₂O)ₙ(SiRR¹O)ₘSiR_{3- g}R¹_{g} (II)
where each R is identical or different and is a monovalent, optionally halogenated hydrocarbon radical having 1 to 18 carbon atom(s) per radical, and
each R¹ is identical or different and is a monovalent hydrocarbon radical having a terminal aliphatic carbon-carbon multiple bond with from 2 to 8 carbon atoms per radical,
g is 0, 1, 2 or 3,
m is 0 or an integer from 1 to 500, and
n is or an integer from 70 to 1000,
with the proviso that the organopolysiloxanes of the formula (II) contain per molecule at least 2 radicals R¹.

9. The process of claim 7, wherein at least one organopolysiloxane (1) is one of the formula
R¹_{g}R_{3- g}SiO(SiR₂O)ₙ(SiRR¹O)ₘSiR_{3- g}R¹_{g} (II)
where each R is identical or different and is a monovalent, optionally halogenated hydrocarbon radical having 1 to 18 carbon atom(s) per radical, and
each R¹ is identical or different and is a monovalent hydrocarbon radical having a terminal aliphatic carbon-carbon multiple bond with from 2 to 8 carbon atoms per radical,
g is 0, 1, 2 or 3,
m is 0 or an integer from 1 to 500, and
n is or an integer from 70 to 1000,
with the proviso that the organopolysiloxanes of the formula (II) contain per molecule at least 2 radicals R¹.

10. The process of claim 6, wherein at least one organopolysiloxane (2) is one of the formula
HₕR_{3- h}SiO(SiR₂O)ₒ(SiR_{2- x}HₓO)ₚSiR_{3- h}Hₕ (IV)
where R is identical or different and is a monovalent, optionally halogenated hydrocarbon radical having 1-18 carbon atom(s) per radical,
h is 0, 1 or 2,
o is 0 or an integer from 1 to 1000,
p is an integer from 1 to 1000, and
x is 1 or 2,
with the proviso that the organopolysiloxanes of the formula (IV) contain from 1.0 to 2.0% by weight of Si-bonded hydrogen.

11. The process of claim 7, wherein at least one organopolysiloxane (2) is one of the formula
HₕR_{3- h}SiO(SiR₂O)ₒ(SiR_{2- x}HₓO)ₚSiR_{3- h}Hₕ (IV)
where R is identical or different and is a monovalent, optionally halogenated hydrocarbon radical having 1-18 carbon atom(s) per radical,
h is 0, 1 or 2,
o is 0 or an integer from 1 to 1000,
p is an integer from 1 to 1000, and
x is 1 or 2,
with the proviso that the organopolysiloxanes of the formula (IV) contain from 1.0 to 2.0% by weight of Si-bonded hydrogen.

12. The process of claim 8, wherein at least one organopolysiloxane (2) is one of the formula
HₕR_{3- h}SiO(SiR₂O)ₒ(SiR_{2- x}HₓO)ₚSiR_{3- h}Hₕ (IV)
where R is identical or different and is a monovalent, optionally halogenated hydrocarbon radical having 1-18 carbon atom(s) per radical,
h is 0, 1 or 2,
o is 0 or an integer from 1 to 1000,
p is an integer from 1 to 1000, and
x is 1 or 2,
with the proviso that the organopolysiloxanes of the formula (IV) contain from 1.0 to 2.0% by weight of Si-bonded hydrogen.

13. The process of claim 9, wherein at least one organopolysiloxane (2) is one of the formula
HₕR_{3- h}SiO(SiR₂O)ₒ(SiR_{2- x}HₓO)ₚSiR_{3- h}Hₕ (IV)
where R is identical or different and is a monovalent, optionally halogenated hydrocarbon radical having 1-18 carbon atom(s) per radical,
h is 0, 1 or 2,
o is 0 or an integer from 1 to 1000,
p is an integer from 1 to 1000, and
x is 1 or 2,
with the proviso that the organopolysiloxanes of the formula (IV) contain from 1.0 to 2.0% by weight of Si-bonded hydrogen.

14. The process of claim 6, wherein the step of treating comprises
a) dipping a bottle cork in the silicone rubber composition under vacuum,
b) mechanically removing excess silicone rubber composition from the bottle cork, and
c) crosslinking the silicone rubber composition.

15. The process of claim 7, wherein the step of treating comprises
a) dipping a bottle cork in the silicone rubber composition under vacuum,
b) mechanically removing excess silicone rubber composition from the bottle cork, and
c) crosslinking the silicone rubber composition.

16. The process of claim 8, wherein the step of treating comprises
a) dipping a bottle cork in the silicone rubber composition under vacuum,
b) mechanically removing excess silicone rubber composition from the bottle cork, and
c) crosslinking the silicone rubber composition.

17. The process of claim 9, wherein the step of treating comprises
a) dipping a bottle cork in the silicone rubber composition under vacuum,
b) mechanically removing excess silicone rubber composition from the bottle cork, and
c) crosslinking the silicone rubber composition.

18. The process of claim 10, wherein the step of treating comprises
a) dipping a bottle cork in the silicone rubber composition under vacuum,
b) mechanically removing excess silicone rubber composition from the bottle cork, and
c) crosslinking the silicone rubber composition.

19. The process of claim 14, wherein said vacuum is broken while said bottle cork is in contact with said silicone rubber composition and prior to mechanically removing excess silicone rubber composition.

20. The process of claim 16, wherein said vacuum is broken while said bottle cork is in contact with said silicone rubber composition and prior to mechanically removing excess silicone rubber composition.

21. The process of claim 18, wherein said vacuum is broken while said bottle cork is in contact with said silicone rubber composition and prior to mechanically removing excess silicone rubber composition.

22. A silicone rubber impregnated bottle cork resistant to loss of surface silicone rubber by abrasion, comprising a bottle cork treated by the process of claim 6.
